(19) United States
(12) Patent Application Publication
(10) Pub. No.: US 2015/0064518 A1
(43) Pub. Date: Mar. 5, 2015

(54) OVER-CURRENT PROTECTION DEVICE AND BATTERY ASSEMBLY

(71) Applicant: Fuzetec Technology Co., Ltd., New Taipei City (TW)

(72) Inventors: Jack Jih-Sang CHEN, New Taipei City (TW); Chang Hung JIANG, New Taipei City (TW)

(73) Assignee: Fuzetec Technology Co., Ltd., New Taipei City (TW)

(21) Appl. No.: 14/013,826

(22) Filed: Aug. 29, 2013

(51) Int. Cl. H02H 7/18; H01M 2/34

(52) U.S. Cl. CPC H02H 7/18; H01M 2/348
USPC 429/62; 361/93.1

(57) ABSTRACT

An over-current protection device includes a PTC element having opposite first and second surfaces; first and second electrode layers attached to the first and second surfaces, respectively; first and second conductive leads respectively attached to the first and second electrode layers and each having an end portion that overlaps the PTC element; and first and second heat-sink layers of a heat dissipating and electrically insulative material attached to and covering the first and second electrode layers and the end portions of the first and second conductive leads. The heat dissipating and electrically insulative material has a thermal conductivity greater than 1.7 W/mK.

### BACKGROUND OF THE INVENTION

1. Field of the Invention

This invention relates to an over-current protection device, more particularly to an over-current protection device including a PTC element and heat-sink layers of a heat dissipating and electrically insulative material having a thermal conductivity greater than 1.7 watts per meter Kelvin (W/mK).

2. Description of the Related Art

A positive temperature coefficient (PTC) device exhibits a PTC effect that renders the same to be useful as a circuit over-current protection, such as a resettable fuse. The PTC device includes a PTC element and first and second electrodes attached to two opposite surfaces of the PTC element, respectively.

U.S. Pat. No. 4,255,698 discloses a rechargeable battery including battery cells and a PTC device that is electrically connected in series with the battery cells and that has a function of protecting the battery cells against over-current during battery charging.

Referring to FIG. 1, U.S. Pat. No. 5,801,612 discloses a battery assembly 8 that includes battery cells 82, 83 and a PTC device 81 that is electrically connected in series with the battery cells 82, 83 for protecting the battery cells 82, 83 against over-temperature and over-current conditions. The PTC device 81 includes a PTC element 811 and first and second electrodes 812, 813 attached to two opposite surfaces of the PTC element 811.

The higher the charging current, the quicker the charging of the battery cells 82, 83 can be completed. Therefore, it is desirable to increase a hold current of the PTC device 81. The term “hold current” (or “pass current”) is used to denote the maximum steady current which can be passed through a PTC device without causing it to trip. Theoretically, the hold current of the PTC device 81 can be increased by increasing the surface area of the PTC device 81. However, the increase in surface area inevitably increases the overall size of the battery assembly 8, which is unfavorable for the current trend toward miniaturization in electronic products.

### SUMMARY OF THE INVENTION

Therefore, an object of the present invention is to provide an over-current protection device that can overcome the aforesaid drawback associated with the prior art.

Another object of this invention is to provide a battery assembly including the over-current protection device.

According to one aspect of this invention, there is provided an over-current protection device that comprises: a PTC element having opposite first and second surfaces and a peripheral end; first and second electrode layers attached to the first and second surfaces, respectively; first and second conductive leads each attached to a respective one of the first and second electrode layers and each having a first end portion that overlaps the PTC element, and a second end portion that extends from the first end portion beyond the peripheral end of the PTC element; and first and second heat-sink layers of a heat dissipating and electrically insulative material each attached to and covering a corresponding one of a pair of the first electrode and the first end portion of the first conductive lead and a pair of the second electrode layer and the first end portion of the second conductive lead. The heat dissipating and electrically insulative material has a thermal conductivity greater than 1.7 W/mK.

According to another aspect of this invention, there is provided a battery assembly that comprises battery cells and an over-current protection device. The over-current protection device is connected electrically to the battery cells and includes: a PTC element having opposite first and second surfaces and a peripheral end; first and second electrode layers attached to the first and second surfaces, respectively; first and second conductive leads each attached to a respective one of the first and second electrode layers and each having a first end portion that overlaps the PTC element, and second end portion that extends from the first end portion beyond the peripheral end of the PTC element, the first and second conductive leads being connected to two of the battery cells, respectively; and first and second heat-sink layers of a heat dissipating and electrically insulative material each attached to and covering a corresponding one of a pair of the first electrode layer and the first end portion of the first conductive lead and a pair of second electrode layer and the first end portion of the second conductive lead. The heat dissipating and electrically insulative material has a thermal conductivity greater than 1.7 W/mK.

### BRIEF DESCRIPTION OF THE DRAWINGS

In drawings which illustrate an embodiment of the invention,

FIG. 1 is a schematic view of a conventional battery assembly disclosed in U.S. Pat. No. 5,801,612;

FIG. 2 is a partly sectional view of the preferred embodiment of a battery assembly according to the present invention; and

FIGS. 3 to 5 are plots showing the relationship between the thermal conductivity and the hold current for test samples of Examples 1-3 and Comparative Examples 1-3 under different test temperatures, respectively.

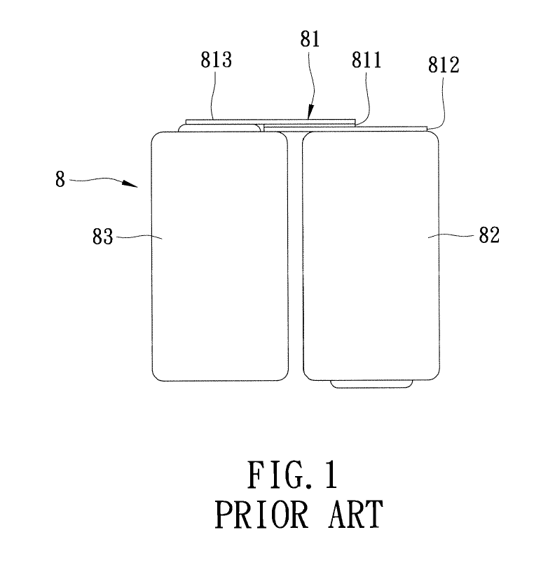

### DETAILED DESCRIPTION OF THE PREFERRED EMBODIMENT

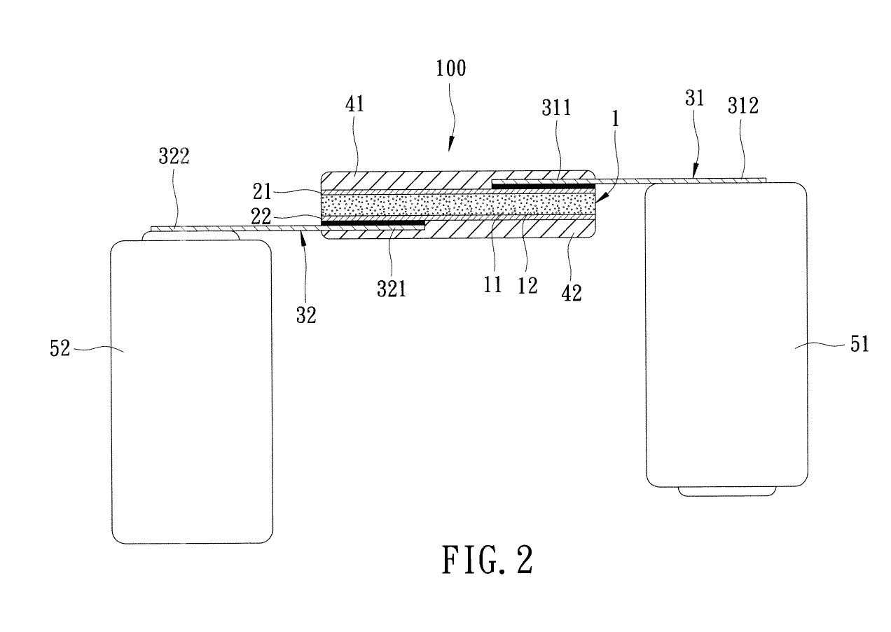

FIG. 2 illustrates the preferred embodiment of a battery assembly according to the present invention. The battery assembly includes two battery cells 51, 52 and an over-current protection device 100 that is electrically connected in series with the battery cells 51, 52.

The over-current protection device 100 includes: a PTC element 1 having opposite first and second surfaces and a peripheral end; first and second electrode layers 21, 22 attached to the first and second surfaces, respectively; first and second conductive leads 31, 32 each attached and soldered to a respective one of the first and second electrode layers 21, 22, using a solder material, and each having a first end portion 311, 321 that overlaps the PTC element 1, and a second end portion 312, 322 that extends from the first end portion 311, 321 beyond the peripheral end of the PTC element 1, the first and second conductive leads 31, 32 being connected to the battery cells 51, 52, respectively; and first and second heat-sink layers 41, 42 of a heat dissipating and electrically insulative material attached to and covering a corresponding one of a pair of the first electrode layer 21 and the first end portion 311 of the first conductive lead 31 and a pair of the second electrode layer 22 and the first end portion 321 of the second conductive lead 32. The heat dissipating and electrically insulative material has a thermal conductivity greater than 1.7 W/mK.

Examples of the heat dissipating and electrically insulative material include, but are not limited to, a thermal conductive adhesive, a thermal conductive tape, and a thermal conductive film. Preferably, the heat dissipating and electrically insulative material is selected from the group consisting of an epoxy-based composite material, an acrylic-based composite material, and a polyester-based composite material.

The PTC element 1 is preferably made from a PTC composition that contains a polymer system 12 and a particulate conductive filler 11 dispersed in the polymer system 12. The polymer system 12 contains a primary polymer unit and a reinforcing polyolefin. The primary polymer unit contains a base polyolefin and optionally a grafted polyolefin. The base polyolefin has a melt flow rate ranging from 10 g/10 min to 100 g/10 min measured according to ASTM. D-1238 under a temperature of 230° C. and a load of 12.6 kg. The reinforcing polyolefin has a melt flow rate ranging from 0.01 g/10 min to 1 g/10 min measured according to ASTM D-1238 under a temperature of 230° C. and a load of 12.6 kg.

Preferably, the weight average molecular weight of the base polyolefin ranges from 50,000 g/mole to 300,000 g/mole, and the weight average molecular weight of the reinforcing polyolefin ranges from 600,000 g/mole to 1,500,000 g/mole.

Preferably, the base polyolefin and the reinforcing polyolefin are high density polyethylene (HDPE) having different weight average molecular weights.

Preferably, the grafted polyolefin is carboxylic acid anhydride grafted HDPE. The grafted polyolefin serves to promote adhesion of the PTC element 1 to the first and the second electrode layers 21, 22.

Preferably, the primary polymer unit is in an amount ranging from 50 to 95 wt % based on the weight of the polymer system 12, and the reinforcing polyolefin is in an amount ranging from 5 to 50 wt % based on the weight of the polymer system 12. More preferably, the amount of the primary polymer unit ranges from 75 to 95 wt % based on the weight of the polymer system 12, and the amount of the reinforcing polyolefin ranges from 5 to 25 wt % based on the weight of the polymer system 12.

Preferably, the reinforcing polyolefin is in an amount ranging from 0.5 to 10 wt % based on the weight of the PTC composition, the primary polymer unit is in an amount ranging from 5 to 20 wt % based on the weight of the PTC composition, and the particulate conductive filler 11 is in an amount ranging from 70 to 90 wt % based on the weight of the PTC composition. More preferably, the reinforcing polyolefin is in an amount ranging from 0.5 to 6 wt % based on the weight of the PTC composition, the primary polymer unit is in an amount ranging from 9 to 18 wt % based on the weight of the PTC composition, and the particulate conductive filler 11 is in an amount ranging from 76 to 90 wt % based on the weight of the PTC composition.

Preferably, the particulate conductive filler 11 is made from a material selected from the group consisting of titanium carbide, zirconium carbide, vanadium carbide, niobium carbide, tantalum carbide, chromium carbide, molybdenum carbide, tungsten carbide, titanium nitride, zirconium nitride, vanadium nitride, niobium nitride, tantalum nitride, chromium nitride, titanium disilicide, zirconium disilicide, niobium disilicide, tungsten disilicide, gold, silver, copper, aluminum, nickel, nickel-metallized glass beads, nickel-metallized graphite, Ti-Tasolidsolution, W—Ti—Ta—Cr solid solution, W—Ta solid solution, W—Ti—Ta—Nb solid solution, W—Ti—Ta solid solution, W—Ti solid solution, Ta—Nb solid solution, and combinations thereof. More preferably, the particulate conductive filler 11 is made from nickel or titanium disilicide.

The following examples and comparative examples are provided to illustrate the preferred embodiment of the invention, and should not be construed as limiting the scope of the invention.

### EXAMPLES

### Example 1 (E1)

4 grams of HDPE (purchased from Ticona company, catalog no.: GHR8110, having a weight average molecular weight of 600,000 g/mole and a melt flow rate of 0.96 g/10 min according to ASTM D-1238 under a temperature of 230° C. and a load of 12.6 Kg) serving as the reinforcing polyolefin, 9 grams of HDPE (purchased from Formosa Plastic Corp., catalog no.: HDPE9002, having a weight average molecular weight of 150,000 g/mole and a melt flow rate of 45/10 min according to ASTM D-1238 under a temperature of 230° C. and a load of 12.6 Kg) serving as the base polyolefin, 9 grams of carboxylic acid anhydride grafted HDPE polyethylene (purchased from Dupont, catalog no.: MB100D, having a weight average molecular weight of 80,000 g/mole and a melt flow rate of 75 g/10 min according to ASTM D-1238 under a temperature of 230° C. and a load of 12.6 Kg) serving as the grated polyolefin, and 178 grams of nickel powder (purchased from Novamet Specialty Products, catalog no.: N525) serving as the particulate conductive filler were compounded in a Brabender mixer. The compounding temperature was 200° C., the stirring rate was 50 rpm, the applied pressure was 5 Kg, and the compounding time was 10 minutes. The compounded mixture was hot pressed so as to form a thin sheet of PTC element 1 having a thickness of 0.43 mm. The hot pressing temperature was 200° C., the hot pressing time was 4 minutes, and the hot pressing pressure was 80 kg/cm². Two copper foil sheets serving as the first and second electrode layers 21, 22 were respectively attached to first and second surfaces of the thin sheet and were hot pressed under 200° C. and 80 kg/cm for 4 minutes to form a sandwiched structure of a PTC laminate. The PTC laminate was cut into a plurality of test samples with a size of 4.5 mm×3.2 mm, and each test sample was irradiated by a cobalt-60 source for a total radiation dose of 130 kGy. First and second conductive leads 31, 32 were soldered to the first and second electrode layers 21, 22 of each test sample using a solder material, respectively. A heat dissipating and electrically insulative material (Manufacturer: T-Global Technology Co., Ltd., catalog no.: Li98C, having a thermal conductivity: 1.8 W/mK) was attached to and used to cover the first and second electrode layers 21, 22 and the first end portions 311, 321 of the first and second conductive leads 31, 32 so as to form first and second heat-sink layers 41,42 on the first and second electrode layers 21, 22, respectively, and so as to form a small sized strap type over-current protection device 100.

The average resistance of the test sample was determined (as shown in Table 1). In Table 1, the term “PE/m-PE” represents the base polyolefin and the grafted polyethylene of the primary polymer unit and the term. “R” represents the average resistance (ohm).

The PTC element 1 thus formed has a composition containing 2 wt % reinforcing polyolefin, 9 wt % primary polymer unit (the weight ratio of the base polyolefin to the grafted polyolefin is 1:1) and 89 wt % particulate conductive filler 11. In addition, the polymer system 12 thus formed has a polymer composition containing 81.8 wt % of the primary polymer unit and 18.2 wt % of the reinforcing polyolefin.

### Examples 2-3 (E2, E3)

The procedures and conditions in preparing the test samples of Examples 2-3 (E2, E3) were similar to those of Example 1 except for the heat dissipating and electrically insulative material (see Table 1). The heat dissipating and electrically insulative material of Example 2 is an epoxy-based composite material (Manufacturer: T-Global Technology Co., Ltd., catalog no.: A98AB, having a thermal conductivity: 2.5 W/mK). The heat dissipating and electrically insulative material of Example 3 is a composite material (Manufacturer: T-Global Technology Co., Ltd., catalog no.: PH3, having a thermal conductivity: 5.0 W/mK) containing an ester-based composite material with a metal film. The average resistances of the test samples of Examples 2-3 were determined (as shown in Table 1).

### Comparative Example 1 (CE1)

The procedures and conditions in preparing the test samples of Comparative Example 1 (CE1) were similar to those of Example 1 except that Comparative Example 1 was free of the heat dissipating and electrically insulative material.

The composition of the PTC element is shown in Table 1. The average resistance of the test samples of Comparative Example 1 was determined (as shown in Table 1).

### Comparative Examples 2-5 (CE2-CE5)

The procedures and conditions in preparing the test samples of Comparative Examples 2-5 (E2-CE5) were similar to those of Example 1 except for the heat dissipating and electrically insulative material.

The heat dissipating and electrically insulative material employed for Comparative Example 2 was a polyester tape (having a thermal conductivity: 0.3 W/mK).

The heat dissipating and electrically insulative material employed for Comparative Example 3 was an epoxy composite material (Manufacturer: Wellunion Electronics Materials Co., Ltd., catalog no.: CF-16, having a thermal conductivity: 0.6 W/mK).

The heat dissipating and electrically insulative material employed for Comparative Example 4 was an acrylic material (Manufacturer: T-Global Technology Co., Ltd., catalog no.: Li98, having a thermal conductivity: 0.95 W/mK).

The heat dissipating and electrically insulative material employed for Comparative Example 5 was a phase change material (Manufacturer: T-Global Technology Co., Ltd., catalog no.: PC99, having a thermal conductivity: 1.5 W/mK).

The compositions of the PTC element of Comparative Examples 2-5 are shown in Table 1. The average resistances of the test samples of Comparative Examples 2-5 were determined (as shown in Table 1).

TABLE 1

| | | | | | Particulate | | Heat dissipating and | | |
|---|---|---|---|---|---|---|---|---|---|
| | Reinforcing | | Primary polymer | | conductive | | electrically insulative | | Measured |
| | polyolefin | | unit | | filler | | material | | property |
| | Catalog | wt | | wt | Catalog | wt | Catalog | thermal | R |
| sample | no. | % | | % | no. | % | no. | conductivity | (ohm) |
| E1 | GHR8110 | 2 | PE/m-PE | 9 | N525 | 89 | Li98C | 1.8 | 0.00698 |
| E2 | GHR8110 | 2 | PE/m-PE | 9 | N525 | 89 | A98AB | 2.5 | 0.00692 |
| E3 | GHR8110 | 2 | PE/m-PE | 9 | N525 | 89 | PH3 | 5.0 | 0.00698 |
| CE1 | GHR8110 | 2 | PE/m-PE | 9 | N525 | 89 | — | 0.0 | 0.00695 |
| CE2 | GHR8110 | 2 | PE/m-PE | 9 | N525 | 89 | Polyester tape | 0.3 | 0.00697 |
| CE3 | GHR8110 | 2 | PE/m-PE | 9 | N525 | 89 | CF-16 | 0.6 | 0.00697 |
| CE4 | GHR8110 | 2 | PE/m-PE | 9 | N525 | 89 | L198 | 0.95 | 0.00697 |
| CE5 | GHR8110 | 2 | PE/m-PE | 9 | N525 | 89 | PC99 | 1.5 | 0.00697 |

<Performance Test>

Hold Current Test:

The test samples of Examples 1-3 and Comparative Examples 1-5 were subjected to hold current test for determining the maximum steady current of each test sample at different temperatures.

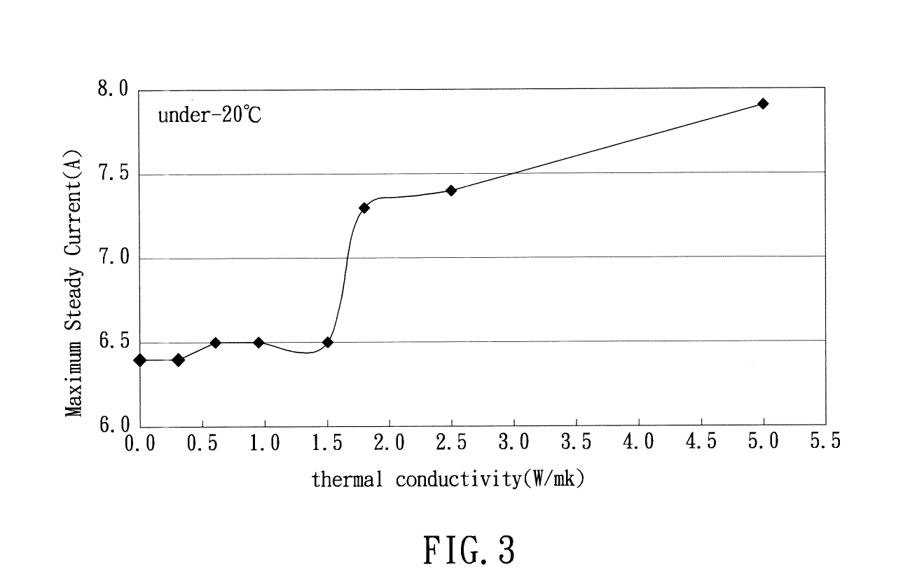

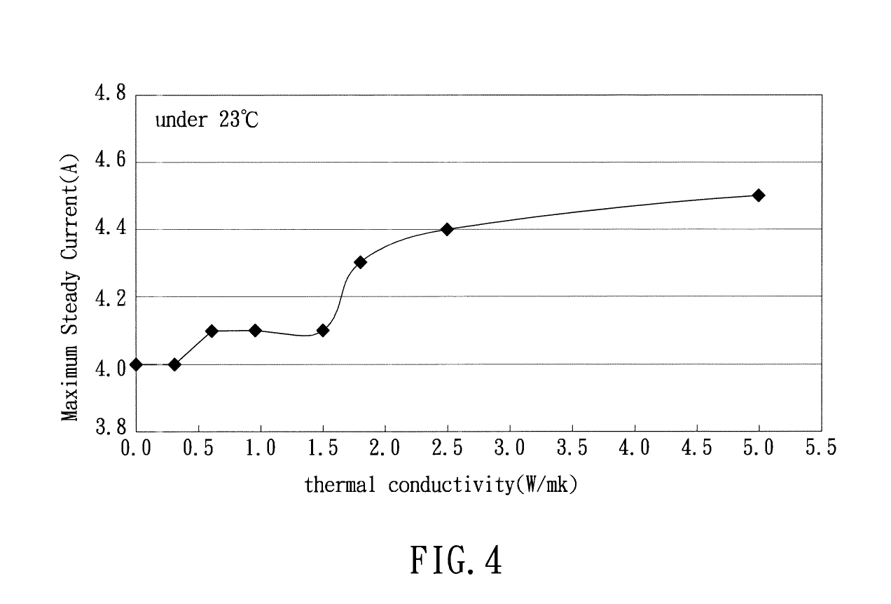

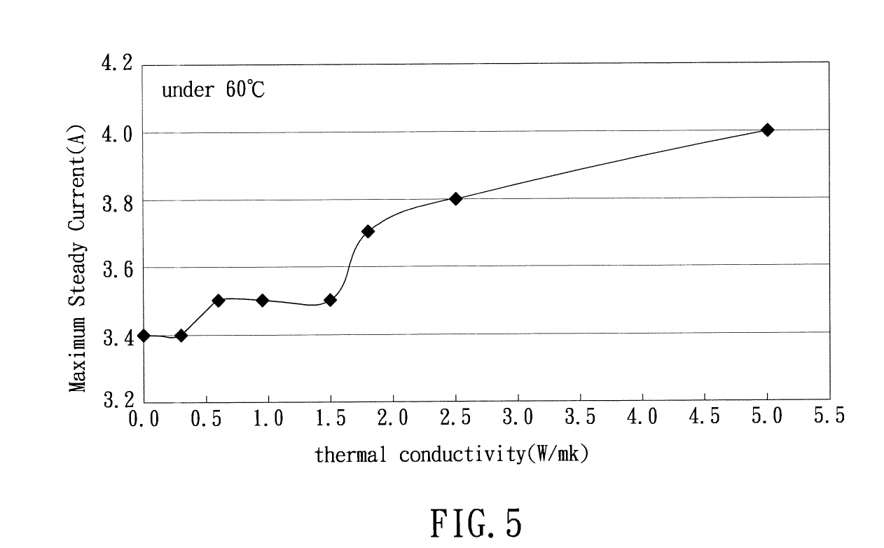

The hold current test for each test sample was conducted under 12V of DC voltage for 15 minutes without causing it to trip under −20° C., 23° C., and 60° C., respectively. The test results are shown in Table 2 and FIGS. 3 to 5.

### Time-to-Trip Test:

The test samples of Examples 1-3 and Comparative Examples 1-5 were further subjected to time-to-trip test for determining the trip time of each test sample at different temperatures. The trip time is defined as the time the over-current protection device takes to trip at a selected trip current under a fixed voltage. The time-to-trip test was conducted under 12 V of DC voltage and a trip current of 15A under −20° C., 23° C., and 60° C., respectively. The test results are listed in Table 2.

TABLE 2

| | Maximum steady | | | Trip time(sec), | | |
|---|---|---|---|---|---|---|
| | Current(A), under 12 V | | | [under 12 V/15 A] | | |
| | −20° C. | 23° C. | 60° C. | −20° C. | 23° C. | 60° C. |
| E1 | 7.3 | 4.3 | 3.7 | 1.99 | 1.44 | 0.74 |
| E2 | 7.4 | 4.4 | 3.8 | 2.00 | 1.53 | 0.76 |
| E3 | 7.9 | 4.5 | 4.0 | 2.08 | 1.49 | 0.78 |
| CE1 | 6.4 | 4.0 | 3.4 | 2.03 | 1.53 | 0.76 |
| CE2 | 6.4 | 4.0 | 3.4 | 2.01 | 1.43 | 0.78 |
| CE3 | 6.5 | 4.1 | 3.5 | 2.02 | 1.44 | 0.77 |
| CE4 | 6.5 | 4.1 | 3.5 | 2.00 | 1.42 | 0.78 |
| CE5 | 6.5 | 4.1 | 3.5 | 2.02 | 1.43 | 0.77 |

FIGS. 3 to 5 are plots showing the relationship between the thermal conductivity of the heat dissipating and electrically insulative material and the hold current for the test samples of Examples 1-3 (with a heat dissipating and electrically insulative material having a thermal conductivity greater than 1.7 W/mK) and Comparative Examples 1-3 (without a heat dissipating and electrically insulative material or with a heat dissipating and electrically insulative material having a thermal conductivity less than 1.7 W/mK) under −20° C., 23° C., and 60° C., respectively.

As shown in Table 2 and FIGS. 3 to 5, the results show that the over-current protection devices of Examples 1-3 have a higher maximum steady current passing through the test samples under −20° C., 23° C., and 60° C. as compared to those of Comparative Examples 1-3.

As shown in Table 2, the trip times of Examples 1-3 and Comparative Examples 1-3 are close to one another for each temperature.

In conclusion, with the inclusion of the first and second heat sink-layers 41, 42 of the heat dissipating and electrically insulative material, having a thermal conductivity greater than 1.7 W/mK, in the over-current protection device 100 of the present invention, the hold current of the over-current protection device 100 can be significantly increased without increasing the surface area of the over-current protection device 100.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. An over-current protection device comprising:
a PTC element having opposite first and second surfaces and a peripheral end;
first and second electrode layers attached to said first and second surfaces, respectively;
first and second conductive leads each attached to a respective one of said first and second electrode layers and each having a first end portion that overlaps said PTC element, and a second end portion that extends from said first end portion beyond said peripheral end of said PTC element; and
first and second heat-sink layers of a heat dissipating and electrically insulative material each attached to and covering a corresponding one of a pair of said first electrode layer and said first end portion of said first conductive lead and a pair of said second electrode layer and said first end portion of said second conductive lead;
wherein said heat dissipating and electrically insulative material has a thermal conductivity greater than 1.7 W/mK.

2. The over-current protection device of claim 1, wherein said heat dissipating and electrically insulative material is selected from the group consisting of an epoxy-based composite material, an acrylic-based composite material, and a polyester-based composite material.

3. The over-current protection device of claim 1, wherein said PTC element is made from a PTO composition that contains a particulate conductive filler and a polymer system, said polymer system containing a primary polymer unit and a reinforcing polyolefin, said primary polymer unit containing a base polyolefin and optionally a grafted polyolefin, said base polyolefin having a melt flow rate ranging from 10 g/10 min to 100 g/10 min measured according to ASTM D-1238 under a temperature of 230° C. and a load of 12.6 Kg, said reinforcing polyolefin having a melt flow rate ranging from 0.01 g/10 min to 1 g/10 min measured according to ASTM D-1238 under a temperature of 230° C. and a load of 12.6 Kg.

4. The over-current protection device of claim 3, wherein the weight average molecular weight of said reinforcing polyolefin ranges from 600,000 g/mole to 1,500,000 g/mole.

5. The over-current protection device of claim 3, wherein the weight average molecular weight of said base polyolefin ranges from 50,000 g/mole to 300,000 g/mole.

6. The over-current protection device of claim 3, wherein said base polyolefin and said reinforcing polyolefin are high density polyethylene.

7. The over-current protection device of claim 3, wherein said grafted polyolefin is carboxylic acid anhydride grafted high density polyethylene.

8. The over-current protection device of claim 3, wherein said particulate conductive filler is made from a material selected from the group consisting of titanium carbide, zirconium carbide, vanadium carbide, niobium carbide, tantalum carbide, chromium carbide, molybdenum carbide, tungsten carbide, titanium nitride, zirconium nitride, vanadium nitride, niobium nitride, tantalum nitride, chromium nitride, titanium disilicide, zirconium disilicide, niobiumdisilicide, tungsten disilicide, gold, silver, copper, aluminum, nickel, nickel-metallized glass beads, nickel-metallized graphite, Ti—Ta solid solution, W—Ti—Ta—Cr solid solution, W—Ta solid solution, W—Ti—Ta—Nb solid solution, W—Ti—Ta solid solution, W—Ti solid solution, Ta—Nb solid solution, and combinations thereof.

9. A battery assembly comprising:
battery cells; and
an over-current protection device connected electrically to said battery cells and including:
a PTC element having opposite first and second surfaces and a peripheral end,
first and second electrode layers attached to said first and second surfaces, respectively,
first and second conductive leads each attached to a respective one of said first and second electrode layers and each having a first end portion that overlaps said PTC element, and a second end portion that extends from said first end portion beyond said peripheral end of said PTC element, said first and second conductive leads being connected to two of the battery cells, respectively, and
first and second heat-sink layers of a heat dissipating and electrically insulative material each attached to and covering a corresponding one of a pair of said first electrode layer and said first endportion of said first conductive lead and a pair of said second electrode layer and said first end portion of said second conductive lead;
wherein said heat dissipating and electrically insulative material has a thermal conductivity greater than 1.7 W/mK.

10. The battery assembly of claim 9, wherein said heat dissipating and electrically insulative material is selected from the group consisting of an epoxy-based composite material, an acrylic-based composite material, and a polyester-based composite material.
